(19) United States
(12) Patent Application Publication
(10) Pub. No.: US 2009/0097148 A1
(43) Pub. Date: Apr. 16, 2009

(54) Head test apparatus and head test analysis system

(75) Inventors: Tetsuya Mukunoki, Kawasaki (JP); Eiji Takada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/232,977

(22) Filed: Sep. 26, 2008

Related U.S. Application Data
(63) Continuation of application No. PCT/JP2006/306860, filed on Mar. 31, 2006.

(51) Int. Cl. G11B 27/36

(52) U.S. Cl. 360/31

(57) ABSTRACT

A head test apparatus includes a loading section that installs the head; a head operation section that causes the head installed in the loading section to execute a test access; a test section that examines the head by judging whether a test access signal obtained from the head when the test access is executed satisfies a predetermined reference; a signal output section that obtains the test access signal and outputs the obtained test access signal to an exterior of the head test apparatus; and a reference output section that outputs a reference signal which is used for taking, in the exterior of the head test apparatus, the test access signal that the signal output section outputs in synchronism with an acquisition of the head test access.

### TECHNICAL FIELD

The present invention relates to a test apparatus and a test analysis system, which perform a test for an object to be examined, and particularly to a head test apparatus which performs a test for a head that accesses a recording medium and outputs an access signal obtained through the access and a head test analysis system that performs such a test as mentioned above and performs a prescribed analytical processing to the access signal.

Hereafter, it explains the example of the magnetic head used for the magnetic disk unit as an examination target. But the examination object is not necessarily the one limited by the magnetic head.

### BACKGROUND ART

In the field of the computer, as the recording medium of information, the magnetic disk, which records information with a magnetization state of the magnetic material, is generally used. To access to such a magnetic disk, there is used a magnetic head which records information by changing the magnetization state of the magnetic material, and reads information by detecting the magnetization state of the magnetic material.

Here, a large amount of computers come to be manufactured in accordance with demand in the market, so that the magnetic head is mass-produced in response to such a situation. Moreover, the magnetic disk is widely used as a recording medium that records music information and image information, etc. for instance in recent years. And, the extension of the use field of such a magnetic disk also gives an impetus to the mass production of the magnetic head.

With the mass production of such magnetic head, there is widely used a magnetic head test apparatus for mass production that examines whether the magnetic head has a necessary performance. Such a magnetic head test apparatus executes the test for the magnetic head in such a way that the magnetic head test apparatus causes a magnetic head, which is an object to be examined, to execute the access for the examination, and judges whether an access signal for the examination that the magnetic head outputs at the access for the examination satisfies a prescribed standard. In this case, a detailed analysis of the access signal for the examination and the like are not done.

On the other hand, when a defective cause is investigated for the magnetic head which causes the defective operation for instance, the access signal that the magnetic head outputs is examined in detail. Thus, there are proposed magnetic head analysis apparatuses which apply prescribed analytical processing to the access signal that the magnetic head outputs (refer to Patent Document 1).

Incidentally, in recent years, a development of the magnetic head is active, and a new magnetic head comes to be developed one after another. However, magnetic head's shape and access principle, etc. often become the one that was different from old goods by the process of such development. Therefore, there might be developed the situation such as it is not possible to operate by installing a new magnetic head in the magnetic head test apparatus and the magnetic head analysis apparatus used for the examination and the analysis to old goods, and it is necessary to remodel those apparatuses and the control program of matches to a new magnetic head.

Here, because the magnetic head test apparatus is restricted in the function and there are a lot of numbers of production, it is relatively cheap. Therefore, it often happens that control programs are also remodeled in accordance with the appearance of a new magnetic head. On the other hand, it is realistically difficult to remodel the apparatus and the control program so as to match those to the magnetic head test apparatus whenever the magnetic head is newly developed, in view of the fact that the component part is expensive and the number of production is few and generally expensive up.

Therefore, only the magnetic head test apparatus for cheap mass production is set up on the site for test and analysis of the magnetic head on the assumption of the future remodeling, and the magnetic head analysis apparatus might be substituted with a combination of the magnetic head test apparatus for the mass production and external apparatuses that are able to be used permanently regardless of old and new of the magnetic head such as oscilloscopes for instance.

In the composition that uses the oscilloscope for instance, the magnetic head is installed in the magnetic head test apparatus and operated. And, the access signal that the magnetic head outputs at the operation is taken into the oscilloscope, and a concrete shape of waves of the access signal is displayed on the monitor screen of the oscilloscope. The user sees the shape of waves displayed on the monitor screen to perform the analysis that suits the purpose such as investigations of defective operation of the magnetic head for instance. Moreover, when a new magnetic head appears, the analysis of the access signal that the new magnetic head outputs becomes possible in such a manner that the magnetic head test apparatus is remodeled to be matched to the new magnetic head together with the control program.

Patent Document 1: TokuKai. 2003-6823 However, since the magnetic head test apparatus is composed aiming to examine the magnetic head originally in the apparatus, some devices are needed to take the access signal that the magnetic head outputs into an external device such as oscilloscopes appropriately. It is a current state that an individual user is doing empirically such a device, and it is a big load when the access signal is analyzed without using the expensive analytical device as mentioned above.

It explained even here, as to the magnetic head test apparatus that examines the magnetic head which accesses the magnetic disk, the problem that it is difficult to make an external device appropriately take in the access signal. However, such a problem is a problem of the head test apparatus that examines heads other than the magnetic head such as optical heads that access the optical disk where information is recorded in optics, which is similarly caused. In addition, such a problem is a problem of the test apparatus that performs the measurement or the examination to be examined, which is caused generally not limited to these head test apparatuses.

In view of the foregoing, it is an object of the present invention to provide a test apparatus that can take examination information obtained through measurement or examination to examination object appropriately to external device and easily, and a test analysis system that can easily execute analysis to such examination information, and particularly a head test apparatus that can take appropriately and easily an access signal that is output when a head accesses recording medium into an external device and a head test analysis system that can perform easily the analysis for such an access signal.

### DISCLOSURE OF THE INVENTION

To achieve the above-mentioned object, the present invention provides a test apparatus that performs measurement or a test for an object to be examined, the test apparatus including:

an information obtaining section that obtains test information from the object to be examined;

a judgment section that judges whether the test information obtained from the information obtaining section satisfies a condition that is a standard of measurement;

a test information output section that outputs the test information to an external device connected with an exterior of the test apparatus; and

a reference output section that outputs to the external device a reference signal that is used for capturing, at the external device, the test information output from the test information output section in synchronism with an obtaining of the test information by the information obtaining section.

According to the test apparatus of the present invention, the information obtaining section performs measurement or test for an object to be examined, and the output section outputs the test information to the external device. The use of the reference signal generated from the reference output section makes it possible to easily implement an appropriate taking that synchronizes with the acquisition of the test information with an external device such as oscilloscopes for instance. Moreover, this feature makes it possible to easily implement the use in which the test apparatus of the present invention is used as a test apparatus assuming that the test apparatus of the present invention is remodeled together with the control program to match the appearance of a new test object for instance, and the test apparatus is combined with an external device that can be permanently used independently of old and new head, so that it is applied to the substitution of an analytical device to analyze the test information.

To achieve the above-mentioned object, the present invention provides a test analysis system including a test apparatus that performs measurement or a test for an object to be examined, and an external device that captures test information obtained by the test apparatus and applies a predetermined analytical processing to the captured test information,

wherein the test apparatus includes:

an information obtaining section that obtains test information from the object to be examined;

a judgment section that judges whether the test information obtained from the information obtaining section satisfies a condition that is a standard of measurement;

a test information output section that outputs the test information to an exterior of the test apparatus; and

a reference output section that outputs to the external device a reference signal that is used for capturing, at the external device, the test information output from the test information output section in synchronism with an obtaining of the test information by the information obtaining section, and

wherein the external device captures the test information output from the test information output section in synchronism with an obtaining of the test information by the information obtaining section, in accordance with the reference signal output from the reference output section.

According to the head test analysis system of the present invention, it is possible to adequately and easily take and analyze the access signal generated from the head installed in the head test apparatus, with the external device in accordance with the reference signal.

According to the test analysis system of the present invention, it is possible to adequately and easily take and analyze the test information generated from the test apparatus, with the external device in accordance with the reference signal. Further, according to the test analysis system of the present invention, when a new object to be examined appears, the test apparatus of the present invention is remodeled together with the control program to match the new magnetic head. This feature makes it possible to analyze the access signal generated from the new head.

To achieve the above-mentioned object, the present invention provides a head test apparatus that examines a head which accesses a recording medium and outputs an access signal obtained through the access, the head test apparatus comprising:

a loading section that installs the head;

a head operation section that causes the head installed in the loading section to execute a test access;

a test section that examines the head in such a manner that a test access signal, which is output from the head when the test access is executed, is obtained, and it is judged whether the obtained test access signal satisfies a predetermined reference;

a signal output section that obtains the test access signal and outputs the obtained test access signal to an exterior of the head test apparatus; and

a reference output section that outputs a reference signal which is used for capturing, in the exterior of the head test apparatus, the test access signal output from the signal output section in synchronism with the test access.

According to the head test apparatus of the present invention, the test section examines the head as an object to be examined, and the signal output section outputs the test access signal generated from the head to the external device. The use of the reference signal generated from the reference output section makes it possible to easily implement an appropriate taking that synchronizes with the test access, of the test access signal, with an external device such as oscilloscopes for instance, which is set out of the head test apparatus. Moreover, this feature makes it possible to easily implement the use in which the head test apparatus of the present invention is used as a head test apparatus assuming that the head test apparatus of the present invention is remodeled together with the control program to match the appearance of a new head for instance, and the head test apparatus is combined with an external device that can be permanently used independently of old and new head, so that it is applied to the substitution of an analytical device to analyze the test access signal.

In the head test apparatus according to the present invention as mentioned above, it is preferable that “the head operation section causes the head installed in the loading section to execute a test access under each of a plurality of types of access conditions,

the test section has references respectively associated with the plurality of types of access conditions, as the predetermined reference, and judges whether the test access signal output from the head under each access condition satisfies a reference associated with the access condition, and

the head operation section has a condition notification section that notifies an exterior of the head test apparatus of the access condition associated with the test access to be executed by the head.”

According to the head test apparatus as mentioned above, for instance, the examination of various types under the access condition of two or more kinds can be executed about the above-mentioned head, and the test access signal of various types obtained under the access condition of two or more kinds can be taken appropriately in accordance with individual access condition notified by the condition notification.

In the head test apparatus according to the present invention as mentioned above, it is preferable that “the test access signal is captured after a predetermined preparation is executed in the exterior of the head test apparatus,

the head test apparatus further comprises a confirmation section that performs a confirmation of completion of the predetermined preparation in the exterior of the head test apparatus, and a confirmation of termination of capturing a result of the test access in the exterior, and

the head operation section causes the head installed in the loading section to execute the test access during a period of time until the confirmation section confirms the termination of capturing after confirming the completion of the preparation.”

According to the head test apparatus as mentioned above, the test access is begun after the completion of the preparation in the exterior, and the test access is continued to the end of the taking. This feature makes it possible to expect more certain taking of the test access signal.

In the head test apparatus according to the present invention as mentioned above, it is preferable that “the test access signal is captured in a predetermined external device in the exterior of the head test apparatus,

the head test apparatus further comprises a detection section that detects a connection state that the predetermined external device is electrically connected with the head test apparatus,

the signal output section outputs the test access signal when the detection section detects the connection state, and

the reference output section outputs the reference signal when the detection section detects the connection state.”

According to the head test apparatus as mentioned above, it is effective since the access signal and the reference signal are generated when the detection section detects the connection state.

To achieve the above-mentioned object, the present invention provides a head test analysis system including a head test apparatus that examines a head which accesses a recording medium and outputs an access signal obtained through the access, and an external device that captures the access signal output from the head and applies a predetermined analytical processing to the access signal,

wherein the head test apparatus includes:

a loading section that installs the head;

a head operation section that causes the head installed in the loading section to execute a test access;

a test section that examines the head in such a manner that a test access signal, which is output from the head when the test access is executed, is obtained, and it is judged whether the obtained test access signal satisfies a predetermined reference;

a signal output section that obtains the test access signal and outputs the obtained test access signal to an exterior of the head test apparatus; and

a reference output section that outputs a reference signal which is used for capturing, in the exterior of the head test apparatus, the test access signal output from the signal output section in synchronism with the test access, and

wherein the external device captures the test access signal output from the signal output section in synchronism with the test access, in accordance with the reference signal output from the reference output section.

According to the head test analysis system as mentioned above, it is possible that the external device appropriately and easily take and analyze the access signal generated from the head installed in the head test apparatus in accordance with the reference signal. Moreover, according to the head test analysis system as mentioned above, when a new head appears, it is possible to analyze the access signal that the new head outputs in such a manner that the head test analysis system is remodeled to match to the new magnetic head with the control program.

In the head test analysis system according to the present invention as mentioned above, it is preferable that “the head test apparatus further includes an evaluation device that has a standard signal input section for inputting a predetermined standard signal to replace the test access signal output from the head, and that has an evaluation section for obtaining an output standard signal output from the signal output section when the signal output section obtains the predetermined standard signal input by the standard signal input section and for evaluating the head test apparatus in accordance with the output standard signal.”

According to the head test analysis system as mentioned above, it is possible to understand how the state of the head test apparatus comes off from the state of the target for instance by evaluation based on the standard signal generated from the signal output section.

Though the head test analysis system referred to in the present invention is stopped to show only a peculiar form and the basic form here, the reason for doing so is to simply avoid overlapping, and various forms corresponding to each form of not only the above-mentioned form but also the above-mentioned head test apparatus are included in the head test analysis system referred to the present invention.

As mentioned above, according to the present invention, it is possible to provide a test apparatus that can take examination information obtained through measurement or examination to examination object appropriately to external device and easily, and a test analysis system that can easily execute analysis to such examination information, and particularly a head test apparatus that can take appropriately and easily an access signal that is output when a head accesses recording medium into an external device and a head test analysis system that can perform easily the analysis for such an access signal.

### BRIEF DESCRIPTION OF THE DRAWINGS

FIG. 1 is a view useful for understanding a first head test analysis system according to a first embodiment of the present invention.

FIG. 2 is a functional block diagram useful for understanding a test control board group 151 and a communication board 152.

FIG. 3 is a flowchart useful for understanding a main routine for processing at the side of a head test apparatus 10 in the first head test analysis system.

FIG. 4 is a flowchart useful for understanding a main routine for processing at the side of a function enhancing apparatus 20 in the first head test analysis system.

FIG. 5 is a flowchart typically showing three subroutines in the flowchart of FIG. 3.

FIG. 6 is a flowchart showing the subroutine in the flowchart of FIG. 4.

FIG. 7 is an explanatory view useful for understanding a taking-in of a test access signal.

FIG. 8 is a view useful for understanding a second head test analysis system according to a second embodiment of the present invention.

### BEST MODE FOR CARRYING OUT THE INVENTION

Hereinafter there will be explained embodiments of the present invention in conjunction with the drawings.

First, there will be explained a first embodiment of the present invention.

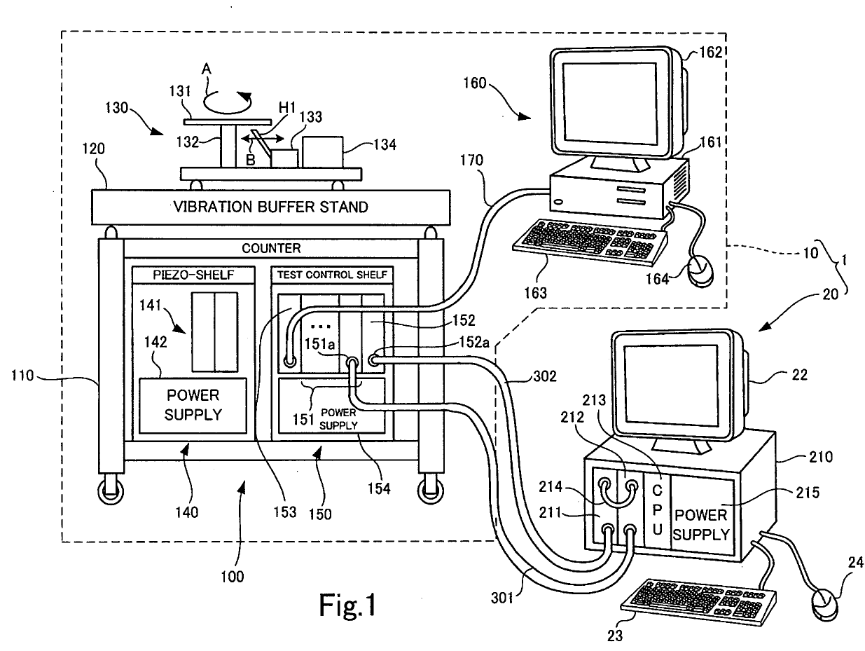

FIG. 1 is a view useful for understanding a first head test analysis system according to the first embodiment of the present invention.

The first head test analysis system 1 shown in FIG. 1 accesses the magnetic disk that records information with a state of the magnetization of the magnetic material, examines the magnetic head which outputs the access signal obtained through the access, and applies prescribed analytical processing to the access signal. The first head test analysis system 1 comprises a head test apparatus 10 that examines a magnetic head and a function enhancing apparatus 20 that executes analytical processing to the access signal.

The head test apparatus 10 is a device for mass production in which it is the main target to examine in a short time whether the magnetic head, which is an object to be examined, has a necessary performance. Since the head test apparatus 10 directly operates the magnetic head which is an object to be examined as will be described later, when a new magnetic head appears, it is required for the head test apparatus 10 to be remodeled together with the control program according to the new magnetic head. On the other hand, the function enhancing apparatus 20 takes the access signal obtained by the head test apparatus 10 and executes the analytical processing, but does not directly operate the magnetic head which is an object to be examined. Thus, the function enhancing apparatus 20 is used permanently independent of the magnetic head being of old and new.

The first head test analysis system 1 shown in FIG. 1 is operated basically as follows. First of all, the head test apparatus 10 is set up in a workshop, and the quality judgment of the head is carried out with the head test apparatus 10. And, when the work that cannot correspond by the head test apparatus 10 only, such as a work that gives prescribed analytical processing to the access signal to investigate the cause of the defective operation about the magnetic head which causes the defective operation for instance, is performed, the function enhancing apparatus 20 is carried beside the head test apparatus 10, and function enhancing apparatus 20 is connected with the head test apparatus 10.

The first head test analysis system 1 corresponds to one embodiment that combines the test analysis system of the present invention and the head test analysis system of the present invention, the head test apparatus 10 corresponds to one embodiment that combines the test apparatus of the present invention and the head test apparatus of the present invention, and the function enhancing apparatus 20 corresponds to one embodiment of the external apparatus referred to in the present invention.

First, there will be explained the head test apparatus 10.

A magnetic head H1 to be examined is installed in the head test apparatus 10. The head test apparatus 10 is composed of a test execution section 100 that executes a test for the loaded magnetic head H1, a computer 160 that performs an operational control for the test execution section 100 and a display for the test result, and a first connection cable 170 that connects both the test execution section 100 and the computer 160.

The test execution section 100 is provided with a counter 110, a vibration buffer stand 120, a loading section 130, a minute movement mechanism shelf 140, and a test control shelf 150.

The counter 110 accommodates the minute movement mechanism shelf 140 and the test control shelf 150, and serves as a stand where the vibration buffer stand 120 is put.

The vibration buffer stand 120 serves as a stand where the loading section 130 is put, and prevents the vibration being transmitted to the loading section 130.

The loading section 130 installs the magnetic head H1 which is to be examined. The loading section 130 corresponds to the loading section referred to in the present invention.

The loading section 130 is provided with a test magnetic disk 131, a motor 132, a head support section 133, and an interface section 134. The test magnetic disk 131 is a target magnetic disk for the access for the examination which is carried out by the magnetic head H1 to be examined. The motor 132 Motor 132 is to perform the rotation drive in the direction of arrow A as for the test magnetic disk 131. The head support section 133 supports the magnetic head H1 to be examined, and moves relatively the magnetic head H1 to the test magnetic disk 131. The interface section 134 mediates the control signal from the minute movement mechanism shelf 140 and the test control shelf 150 to the loading section 130. Further, the interface section 134 transmits to the test control shelf 150 the access signal for the examination that is output from the magnetic head H1 to be examined when it accesses the test magnetic disk 131, after applying the signal processing such as amplification by a prescribed gain.

According to the present embodiment, the minute movement mechanism performs accurately a relative displacement of the test magnetic disk 131 in a radius direction (direction of arrow B) among relative displacements of the magnetic head H1 executed in the head support section 133 to the test magnetic disk 131.

The minute movement mechanism shelf 140 accommodates the mechanism that controls the operation of the minute movement mechanism of the head support section 133 in accordance with the instruction from the test control shelf 150. The minute movement mechanism shelf 140 is provided with a control board group 141 for minute movement mechanism and a power supply 142 for supplying electric power to the control board group.

The test control shelf 150 accommodates the mechanism to control the test access operations of the magnetic head H1 in its entirety such as the relative displacement of the magnetic head H1 to be examined to the test magnetic disk 131, and writing operation and reading operation for information to the test magnetic disk 131. In addition, the test control shelf 150 examines whether the magnetic head H1 to be examined has a necessary performance in judging whether the test access signal sent from the loading section 130 fills a prescribed standard. Moreover, the test control shelf 150 outputs the test access signal transmitted from the loading section 130 to the function enhancing apparatus 20, and exchanges various information described later to analyze the test access signal appropriately with the function enhancing apparatus 20.

The test control shelf 150 is provided with a test control board group 151, a communication board 152, an interface board 153, and a power supply 154.

The test control board group 151 performs the control of the access whole for the examination including the instruction to the above-mentioned minute movement mechanism shelf 140 and the above-mentioned examination. One of the boards constituting the test control board group 151 is provided with an access signal connector 151a which is an outlet of the test access signal. The test control board group 151 outputs the test access signal, which is sent from the loading section 130, to the function enhancing apparatus 20 in the state of the analog signal through a second connection cable 301 connected with the access signal connector 151a.

In the communication board 152, the test access signal output from the test control board group 151 is taken appropriately into the function enhancing apparatus 20, and exchanges various kinds of information to be analyzed between the communication board 152 and the function enhancing apparatus 20. The communication board 152 has an information connector 152a that serves as inlet and outlet for information. An exchange of the information is carried out through a third connection cable 302 connected with the information connector 152a.

There will be explained later in detail as to the test control board group 151 and the communication board 152.

The interface board 153 has a connector to which the first connection cable 170 is connected with. The interface board 153 receives the instruction from the computer 160 to test execution section 100 through the first connection cable 170 connected with the connector, and transmits the test result obtained in the test execution section 100 to the computer 160.

The power supply 154 supplies the electric power necessary for each board that composes the test control shelf 150 as explained above.

The computer 160 performs the operational control of the test execution section 100 and displays the test result as mentioned above. The computer 160 has: a main frame section 161 which incorporates therein CPU, RAM memory, a hard disk, and the like; a monitor 162 that performs an image display; a keyboard 163 that inputs user's instruction and character information to the computer 160; and a mouse 164 that designates a desired position on the monitor 162 to input an instruction according to the position. The hard disk of the computer 160 stores therein programs to perform operation control for the test execution section 100 and processing for quality judgment of the head, etc.

A detailed explanation for the test control board group 151 and the communication board will be made later, and next the function enhancing apparatus 20 will be explained.

The function enhancing apparatus 20 takes the test access signal obtained with the head test apparatus 10 and executes analytical processing. The function enhancing apparatus 20 has: a main frame section 210; a monitor 22 that displays analytical results and the like; a keyboard 23 that inputs user's instruction and character information to the function enhancing apparatus 20; and a mouse 24 that designates a desired position on the monitor 22 to input an instruction according to the position. The function enhancing apparatus 20 has a storage section that is composed of a hard disk (not illustrated). The hard disk of the function enhancing apparatus 20 stores therein programs to perform analytical processing using the test access signal.

The main frame section 210 is composed of a communication board 211, A/DC (analogue/digital conversion) board 212, CPU board 213, a trigger transmission cable 214, and a power supply 215.

The communication board 211 is electrically connected with the communication board 152 of the head test apparatus 10 by the third connection cable 302. The communication board 211 performs an exchange of information described later via the third connection cable 302 with the communication board 152 of the head test apparatus 10, and generates a trigger pulse, which indicates taking beginning of the test access signal, in accordance with the exchange of information. The generated trigger pulse is transmitted via a trigger transmission cable 214 to the A/DC board 212.

The A/DC board 212 is electrically connected with the test control board group 151 of the head test apparatus 10 by the second connection cable 301. The A/DC board 212 applies A/DC (analogue/digital conversion) processing to the test access signal which is transmitted in form of the analog signal from the test control board group 151 via the second connection cable 301, so that the test access signal is taken into the function enhancing apparatus 20 in form of the analog signal. The function enhancing apparatus 20 starts taking of the test access signal in timing of transmission of the trigger pulse.

Here, there will be explained in detail generation of the trigger pulse and taking of the test access signal in conjunction with a detailed explanation for the test control board group 151 and the communication board 152.

The CPU board 213 controls the operation of the function enhancing apparatus 20 in its entirety, and applies analytical processing to the test access signal that the A/DC board 212 takes.

The power supply 215 supplies the electric power necessary for individual section of the function enhancing apparatus 20.

Next, there will be explained details of the test control board group 151 and the communication board 152 in the test control shelf 150.

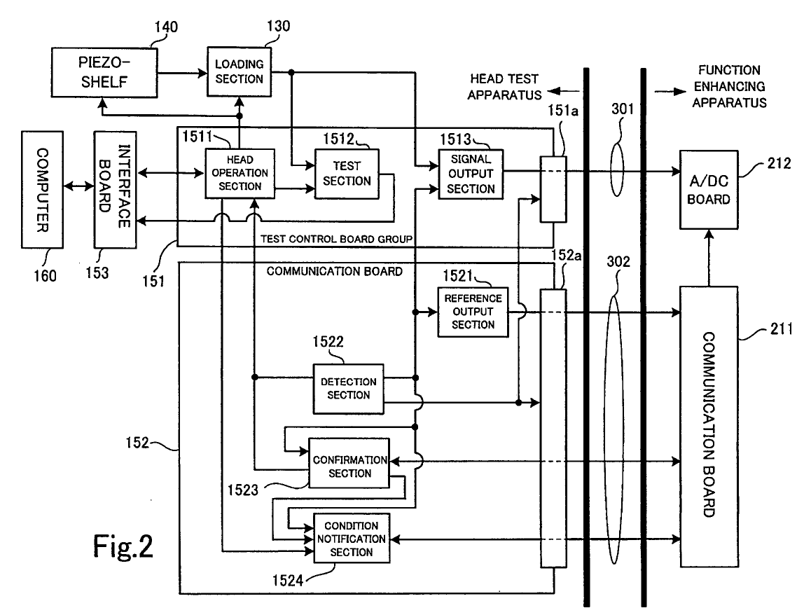

FIG. 2 is a functional block diagram useful for understanding a test control board group 151 and a communication board 152.

FIG. 2 typically shows: an interface board 153 of the test control shelf 150 provided on the side of the head test apparatus 10; the computer 160; the minute movement mechanism shelf 140; and the loading section 130 as well as the test control board group 151 and the communication board 152 in the test control shelf 150. FIG. 2 further shows the communication board 211 and the A/DC board 212, which are provided on the side of the function enhancing apparatus 20.

As shown in FIG. 2, the test control board group 151 has a head operation section 1511, a test section 1512, and a signal output section 1513. The communication board 152 has a reference output section 1521, a detection section 1522, a confirmation section 1523, and a condition notification section 1524. The head operation section 1511, the test section 1512, and the signal output section 1513 correspond to examples of the head operation section, the test section, and the signal output section referred to in the present invention, respectively. The reference output section 1521, the detection section 1522, the confirmation section 1523, and the condition notification section 1524 correspond to examples of the reference output section, the detection section, the confirmation section, and the condition notification section referred to in the present invention, respectively. The test section 1512 serves as examples of the information obtaining section and the judgment section referred to in the present invention, too. The signal output section 1513 serves as one example of the output section, too.

The head operation section 1511 controls the test access whole including the instruction to the minute movement mechanism shelf 140. The control by the head operation section 1511 performs such a series of test access that the magnetic head of the test object installed in the loading section 130 is moved to a prescribed test position in the vicinity of the test magnetic disk 131 (Refer to FIG. 1), a prescribed test information is written into the magnetic disk 131 at the test position, and the written information is read. According to the present embodiment, the head operation section 1511 has the function to make the magnetic head to be examined execute the test access of two or more patterns under individual access condition of two or more kinds which are different from one another in rotational speed etc. of the test magnetic disk 131, and the test information and the test position when the magnetic head reads and writes information. The computer 160 issues an instruction as to making the magnetic head to be examined execute the test access under which kind of access condition, through the interface board 153 to the head operation section 1511. The head operation section 1511 transmits the instruction from the computer 160 to the test section 1512 and the condition notification section 1524 of the communication that board 152 in the test control shelf 150.

When the magnetic head to be examined reads information in the test access, the test section 1512 acquires the test access signal outputted from the magnetic head, to which the amplification processing and like are applied by the loading section 130. And the test section 1512 judges whether the obtained test access signal satisfies a prescribed reference. The test section 1512 performs the judgment according to individual one of the above-mentioned two or more access conditions. According to the present embodiment, the test section 1512 has a function of causing the magnetic head to execute the test access under such an access condition that the magnetic head executes writing and reading of information wherein “1” and “0” are alternately arranged for instance. The test access signal, which is generated from the magnetic head in such a test access, is a pulse signal that is periodical in accordance with an arrangement of the above-mentioned “1” and “0”. The test section 1512 judges whether width and peak value in an individual pulse is within the tolerance, in the test access signal. The head operation section 1511 has a function of executing the test access under such an access condition that for instance, information on a complex content to cause the mistake easily in writing and reading is used. The test section 1512 judges whether the agreement accuracy of the content of information indicated by the test access signal obtained under such an access condition and the content of original information is within the tolerance. According to the present embodiment, the test section 1512 makes a judgment on individual one of such two or more patters of test accesses, so that it is examined whether the magnetic head has a necessary performance. The test result is transmitted via the interface board 153 to the computer 160. The monitor 162 (refer to FIG. 1) of the computer 160 displays the test result.

The head test apparatus 10 shown in FIG. 1 is an apparatus for mass production in which it is a main aim to examine in a short time whether the magnetic head to be examined has a necessary performance. The function of the apparatus for mass production is implemented by the head operation section 1511 and the test section 1512 as mentioned above. Each element of the signal output section 1513 of the for the examination control board group 151 and the communication board 152 comes to function when the function enhancing apparatus 20 is connected with the head test apparatus 10 for the purpose of investigations of the cause of defective operation of the magnetic head.

There will be explained details of the processing executed when the function enhancing apparatus 20 is connected with the head test apparatus 10, in conjunction with another figure, and hereinafter there will be explained outlines of individual elements of signal output section 1513 and the communication board 152.

The reference output section 1521 of the communication board 152 outputs an index pulse and a write gate signal, etc., which are input from the test control board group, to the communication board 211 of the function enhancing apparatus 20.

The communication board 152 detects the fact that the function enhancing apparatus 20 is electrically connected with the head test apparatus 10, in accordance with the signal from the communication board 211 of the function enhancing apparatus 20, and transmits it to the computer 160.

The signal output section 1513 of the test control board group 151 outputs the test access signal obtained by the test access to A/DC board 212 of the function enhancing apparatus 20 in the state of the analog signal through the second connection cable 301 connected with the connector 151a for the access signal.

Incidentally, according to the present embodiment, the function enhancing apparatus 20 has the function to do two kinds of processing of a series of processing of taking the test access signal and analyzing the taken test access signal, and processing besides the test access signal analysis processing. According to the present embodiment, in the event that the function enhancing apparatus 20 is connected with the head test apparatus 10, the head test apparatus 10 properly outputs a start demand to direct the execution of the former processing. Upon receipt of the start demand, the function enhancing apparatus 20 executes the former test access signal analysis processing. When the function enhancing apparatus 20 executes the test access signal analysis processing, first of all, the function enhancing apparatus 20 executes a prescribed preparation before the test access signal is taken, and then executes taking of the test access signal after completion of the preparation.

The confirmation section 1523 of the communication board 152 performs an output of the start demand for the function enhancing apparatus 20, a confirmation as to whether the function enhancing apparatus 20 has completed the preparation for taking the test access signal, and a confirmation as to whether the function enhancing apparatus 20 has completed taking the test access signal. Moreover, the confirmation section 1523 of the communication board 152 confirms whether the function enhancing apparatus 20 can receive the access condition as part of the confirmation of the completion of the above-mentioned preparation. The confirmation section 1523 transmits the result of these confirmations properly to the head operation section 1511 and the condition notification section 1524.

The condition notification section 1524 of the communication board 152 notifies the communication board 211 of the function enhancing apparatus 20 the access condition corresponding to the test access to make the magnetic head to be examined execute it.

The first head test analysis system 1 is composed as mentioned above.

Next, there will be explained details of the first head test analysis system 1 paying attention to the flow of the processing executed with the first head test analysis system 1 when the function enhancing apparatus 20 is connected with the head test apparatus 10. In the following explanations, it refers without especially noting figures for the elements shown in FIG. 1 and FIG. 2.

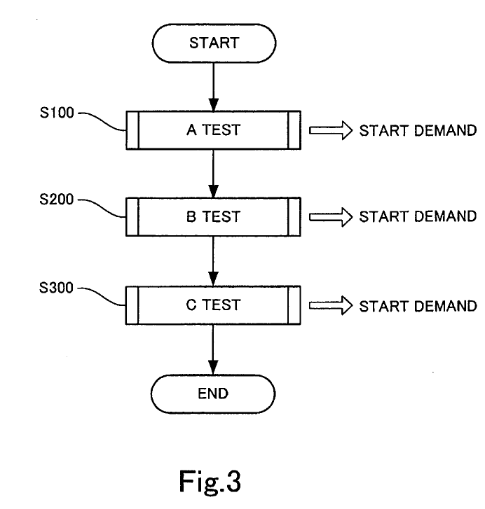

FIG. 3 is a flowchart useful for understanding a main routine for processing at the side of a head test apparatus 10 in the first head test analysis system. It is assumed that various processing shown by the following flowchart are executed by the programs stored in the computer 160 or the function enhancing apparatus 20.

The processing shown in the flowchart of FIG. 3 starts when a user operates the operation screen displayed on the monitor 162, in the computer 160 that composes the head test apparatus 10, and instructs beginning of the test for the magnetic head to be examined.

As mentioned above, the head operation section 1511 has the function to make the magnetic head to be examined execute the test access under individual one of two or more kinds of access conditions. The test section 1512 has the function to perform judgment according to each access condition. In other words, the head test apparatus 10 of the first head test analysis system 1 has the function to apply to the magnetic head to be examined two or more kinds of examination corresponding to individual one of two or more access conditions. According to the present embodiment, the user can select whether to apply it to the magnetic head to be examined which kind of examination of these two or more kinds of examinations by the operation to the operation screen (not illustrated in the figure) which is displayed on the monitor 162 of the computer 160 of the head test apparatus 10. The example of FIG. 3 is one in which the flow of the processing executed with the head test apparatus 10 is shown when the user selects three kinds of examinations. Here, three kinds of examinations that the user selected have been described in FIG. 3 by an abstract name like A test, B test, and C test.

When the processing shown in FIG. 3 starts, the head test apparatus 10 performs the processing in named order of the subroutine (step S10) that shows A-test, the subroutine (step S20) that shows B-test, the subroutine (step S30) that shows C-test, and terminates the processing represented by the flowchart when all the processing of three subroutines ends. When the function enhancing apparatus 20 is connected to the head test apparatus 10, the output of the start demand for the function enhancing apparatus 20 is executed in each subroutine as will be described later.

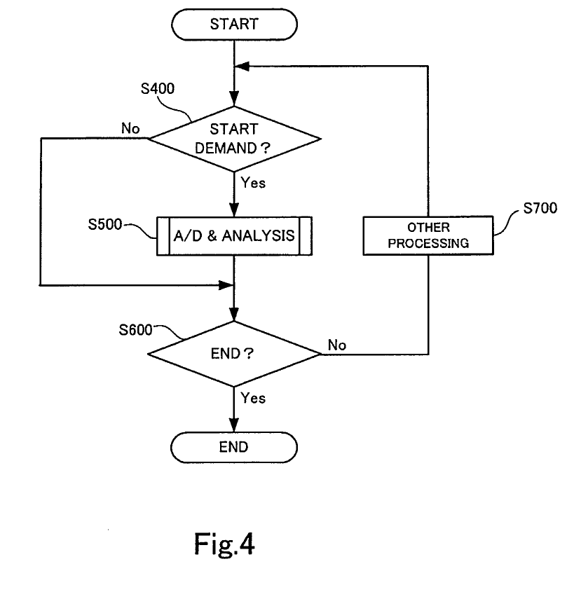

FIG. 4 is a flowchart useful for understanding a main routine for processing at the side of a function enhancing apparatus 20 in the first head test analysis system.

The processing shown by the flowchart of FIG. 4 starts when the power supply is turned on to the function enhancing apparatus 20 by the user, the control program is started, and the measurement preparation is directed.

When the processing shown in FIG. 4 starts, first, it is judged whether the start demand is generated from the head test apparatus 10 (step S400). In the event that the start demand is generated (Yes judgment in step S400), the function enhancing apparatus 20 executes the subroutine (step S500) that shows a series of processing of taking the signal by analogue/digital conversion and analysis for the taken signal. In step S500, as will be described later, there are executed taking and analytical processing associated with the kind of the examination when the start demand is generated from the head test apparatus 10. When the subroutine of step S500 ends, it is judged whether the user issues the instruction of the measurement preparation state release (step S600). When the instruction of the measurement preparation state release is issued (Yes judgment in step S600), the processing of the flowchart of FIG. 4 ends. On the other hand, when the instruction of the measurement preparation state release is not yet issued (No judgment in step S600), the process returns to step S400. In step S400, when the start demand is not generated (No judgment in step S400), the processing of step S500 is skipped, and the processing on and after step S600 is executed.

As shown in the flowchart of FIG. 4, according to the function enhancing apparatus 20, after the control program is started, and it enters the state of the measurement preparation, taking and the analysis of the signal associated with the start demand are executed when the start demand is generated from the head test apparatus 10 in the idle state basically.

Next, there will be explained details of the processing executed respectively of the head test apparatus 10 and the function enhancing apparatus 20 while referring to the subroutines in the flowcharts of FIG. 3 and FIG. 4.

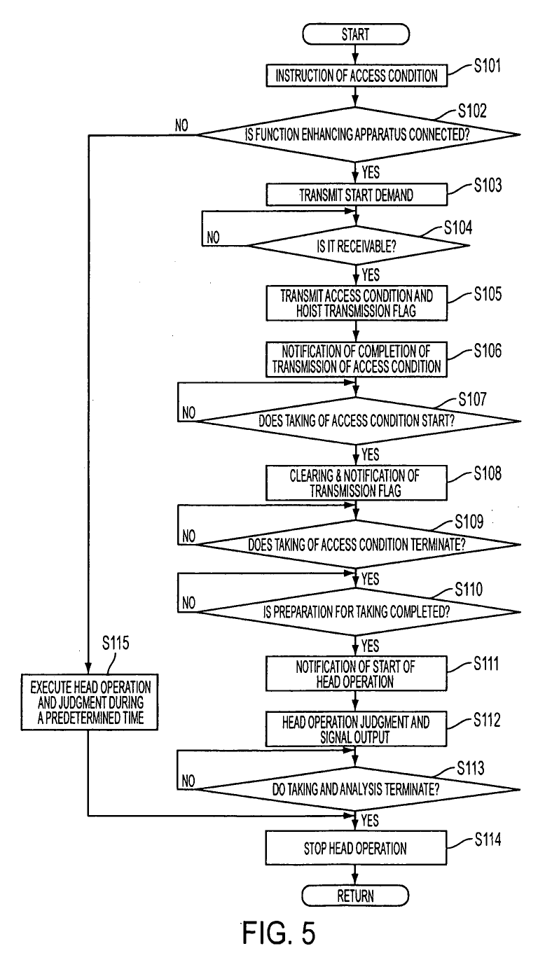

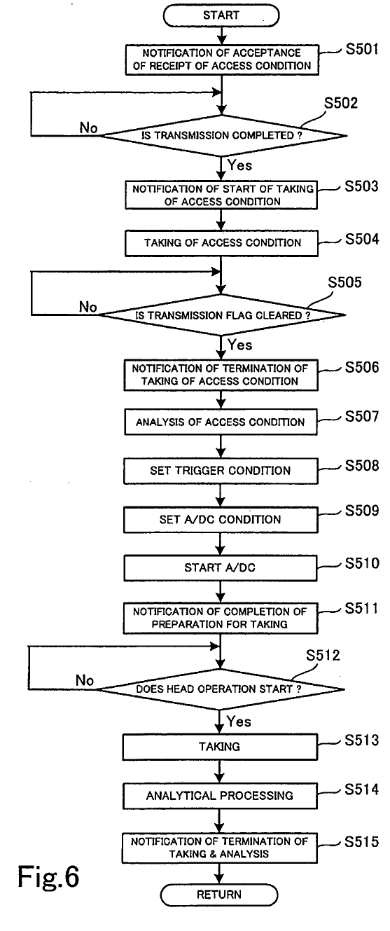

FIG. 5 is a flowchart typically showing three subroutines in the flowchart of FIG. 3. FIG. 6 is a flowchart showing the subroutine in the flowchart of FIG. 4.

The subroutine that the flowchart of FIG. 5 shows is executed with the head test apparatus 10, and the subroutine that the flowchart of FIG. 6 shows is executed with the function enhancing apparatus 20. Each subroutine is executed while mutually cooperating. Then, the following explanations will be done while referring to both flowcharts of FIG. 5 and FIG. 6.

First of all, when the subroutine of FIG. 5 starts in head test apparatus 10, the computer 160 of the head test apparatus 10 instructs whether the head operation section 1511 makes the magnetic head to be examined execute the test access under which kind of access condition of two or more kinds of access conditions (step S101). The head operation section 1511 temporarily memorizes the content of the instruction from the computer 160 in the memory as not illustrated.

Next, the head test apparatus 10 judges whether the function enhancing apparatus 20 is connected with the head test apparatus 10 electrically (step S102). The judgment of step S102 is executed with the detection section 1522 of the head test apparatus 10. When it is judged that the function enhancing apparatus 20 is connected (Yes judgment in step S102), there is generated the start demand to direct the function enhancing apparatus 20 to execute a series of processing of taking the test access signal and analyzing the taken test access signal (step S103). As mentioned above, the start demand is generated from the confirmation section 1523 of the head test apparatus 10. In the head test apparatus 10, it becomes a stand-by state until the function enhancing apparatus 20 side first offers the state that the access condition can be received though the access condition, which is directed from the computer 160 to the head operation section 1511 in step S101, is notified to the function enhancing apparatus 20 (step S104).

In the function enhancing apparatus 20, when the head test apparatus 10 generates the start demand, the subroutine of FIG. 6 starts. It is notified to the head test apparatus 10 that the function enhancing apparatus 20 offers the state that the function enhancing apparatus 20 can receive the above-mentioned access condition after the subroutine is started (step S501). The notification is performed to the confirmation section 1523 of the head test apparatus 10.

According to the head test apparatus 10, in the flowchart of FIG. 5, when the confirmation section 1523 receives from the function enhancing apparatus 20 the notification of the effect that the function enhancing apparatus 20 offers the state that the function enhancing apparatus 20 can receive the above-mentioned access condition (state of Yes in step S104), the condition notification section 1524 transmits the above-mentioned access condition to the function enhancing apparatus 20 (step S105). At that time, a transmission flag that indicates that the access condition is being transmitted is hoisted. When the transmission of the access condition is completed, the condition notification section 1524 notifies the function enhancing apparatus 20 of so (step S106).

The access condition is transmitted in form of coded signal, and stored in a buffer memory (not illustrated) of the communication board 211 of the function enhancing apparatus 20 while transmitting. In the function enhancing apparatus 20, after the transmission from the head test apparatus 10 is completed, the access condition is taken by decoding the encoded signal in the buffer memory.

After completion of processing of step S501 in the flowchart of FIG. 6, the function enhancing apparatus 20 offers a stand-by state until the transmission of the access condition is completed with the head test apparatus 10 (step S502). Upon receipt of the notification of the effect that the transmission is completed from the condition notification section 1524 (Yes judgment in step S502), the function enhancing apparatus 20 notifies the condition notification section 1524 of the start of taking of the access condition (step S503), and executes the taking (step S504).

According to the head test apparatus 10, in the flowchart of FIG. 5, after the processing of step S106 terminates, the head test apparatus 10 offers a stand-by state until the function enhancing apparatus 20 begins taking of the access condition (step S107). The transmission flag hoisted in step S105 is cleared when beginning taking is notified from the function enhancing apparatus 20 to the condition notification section 1524 (Yes judgment in step S107), and the function enhancing apparatus 20 is notified so by the condition notification section 1524 (step S108). Afterwards, the head test apparatus 10 offers a stand-by state until taking of the access condition terminates in the function enhancing apparatus 20 (step S109).

After completion of processing of step S504 in the flowchart of FIG. 6, the function enhancing apparatus 20 offers a stand-by state until the transmission flag is cleared with the head test apparatus 10 side (step S505). Upon receipt of the notification of the effect that the transmission flag is cleared from the condition notification section 1524 (Yes judgment in step S505), the function enhancing apparatus 20 notifies the condition notification section 1524 of the termination of taking of the access condition (step S506). Subsequently, the access condition of taking is analyzed (step S507), and the trigger condition to generate a trigger pulse indicative of the taking beginning of the test access signal is set in accordance with the analytical result (step S508). In addition, the condition (A/DC condition) for analogue/digital conversion in A/DC board 212 for analogue/digital conversion such as the sampling periods is set for instance in accordance with the above-mentioned analytical result (step S509), and A/DC board 212 is started in accordance with the set A/DC condition (step S510). And, when the processing to here ends, the effect that the preparation for taking the access signal is completed is notified to the confirmation section 1523 of the head test apparatus (step S511).

According to the head test apparatus 10, in the flowchart of FIG. 5, when the end of taking of the access condition is notified (Yes judgment in step S109), the head test apparatus 10 offers a stand-by state until the preparation for taking the access signal is completed in function enhancing apparatus 20 (step S110). When the completion of the preparation is notified (Yes judgment in step S110), the confirmation section 1523 notifies the function enhancing apparatus 20 of the effect that the head operation section 1511 begins the operation to make the magnetic head to be examined execute the test access (step S111), and the head operation section 1511 begins the operation (step S112). In step S112, the test section 1512 of the test control board group 151 of the head test apparatus 10 executes the judgment whether the test access signal obtained through the test access executed by the operation satisfies a prescribed reference. The test access and the judgment processing, which are executed in step S112, are the test access and the judgment processing associated with the access condition that is instructed to the head operation section 1511 by the computer 160 in step S101 and stored temporarily in a memory as not illustrated. Moreover, the signal output section 1513 of the test control board group 151 transmits the test access signal obtained through the test access to the A/DC board 212 of the function enhancing apparatus 20 in the state of the analog signal.

After completion of processing of step S511 in the flowchart of FIG. 6, the function enhancing apparatus 20 offers a stand-by state until the head operation section 1511 begins the operation to make the magnetic head to be examined execute the test access (step S512). And, when the function enhancing apparatus 20 is notified of beginning of the operation of the magnetic head, A/DC board 212 takes the test access signal (step S513).

Here, it explains in detail by using another figure about taking the test access signal.

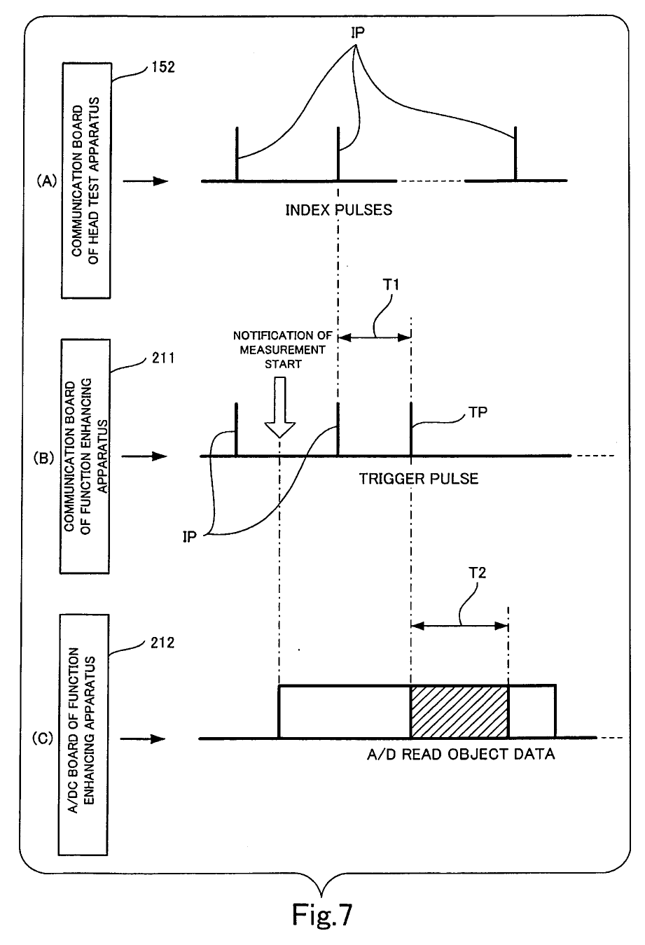

FIG. 7 is an explanatory view useful for understanding a taking-in of a test access signal. Here, there will be explained a case where a trigger pulse that synchronizes with an index pulse is generated.

Index pulses IP are input by the test control board group 151 to the communication board 152 of the head test apparatus 10, as mentioned above. A part (A) of FIG. 7 typically shows the index pulses IP. The index pulses IP are output from the reference output section 1521 of the communication board 152 of the head test apparatus 10 to the communication board 211 of the function enhancing apparatus 20.

When the communication board 211 of the function enhancing apparatus 20 is notified of beginning of the operation of the magnetic head in the step S512, the communication board 211 generates a trigger pulse TP that triggers beginning of analogue/digital conversion with the A/DC board 212 in timing wherein delay time T1 is passes from the index pulse IP that is transmitted immediately after the notification. A part (B) of FIG. 7 typically shows the trigger pulse TP. The delay time T1 is decided to be the best value in the setting of the trigger condition in the step S508 in accordance with the analysis of the access condition executed in the step S507.

When the trigger pulse TP is generated, the A/DC board 212 of the function enhancing apparatus 20 executes the analogue/digital conversion during a certain conversion time T2 after trigger pulse TP generation to convert the test access signal transmitted into a digital signal. The test access signal, which is subjected to the conversion, is stored in a memory (not illustrated) of the function enhancing apparatus 20. A part (C) of FIG. 7 typically shows the timing of the analogue/digital conversion. The conversion time T2 is decided to be the best value in the setting of the A/DC condition in the step S509 in accordance with the analysis of the access condition executed in the step S507.

As explained referring to FIG. 7, upon receipt of the trigger pulse TP generated by using the index pulses IP, the function enhancing apparatus 20 begins taking of the test access signal. This feature makes it possible for the function enhancing apparatus 20 to take the test access signal in surely synchronizing with the test access executed with head examination device 10.

It explains the processing of the remainder in the head test apparatus 10 and the function enhancing apparatus 20 respectively referring to FIG. 5 and FIG. 6 again.

After completion of taking of the test access signal of step S513 in the flowchart of FIG. 6, in the function enhancing apparatus 20, CPU board 213 of the function enhancing apparatus 20 executes analytical processing such as the frequency analysis for the test access signal taken (step S514). When the analytical processing ends, the communication board 211 of the function enhancing apparatus 20 notifies the confirmation section 1523 of the communication board 152 of the head examination apparatus 10 of the effect that taking and analytical processing for the test access signal terminate (step S515). After termination of the processing of step S515, the processing of the function enhancing apparatus 20 returns to the main routine of the flowchart of FIG. 4.

According to the head test apparatus 10, in the flowchart of FIG. 5, the head test apparatus 10 continues operation of the magnetic head until taking and analytical processing for the test access signal in the function enhancing apparatus 20 terminate after the operation of the magnetic head starts in step S112 (step S113). When the head test apparatus 10 is notified of the termination of these processing from the function enhancing apparatus 20 (Yes judgment in step S113), the head operation section 1511 of the test control board group 151 of the head test apparatus 10 stops the operation of the magnetic head (step S114).

In the head apparatus 10, in step S102 of the flowchart of FIG. 5, when it is judged that the function enhancing apparatus 20 is not connected (No judgment in step S102), the judgment processing for the test access by the operation of the head operation section 1511 and the test access signal by the test section 1512 is executed during a prescribed time required for the judgment processing, instead of processing from step S103 explained here to step S113 (step S115), and the operation for the magnetic head is stopped in step S114. According to the present embodiment, the test access and the judgment processing executed in step S112 and test access and the judgment processing executed in step S115 are homogeneous in each other. However, the test access is continued in processing from step S112 to step S113 until taking and analytical processing of the test access signal in the function enhancing apparatus 20 terminate while the test access is stopped at once in processing of step S115 when the judgment processing ends.

Processing in the head test apparatus 10 returns to the main routine of the flowchart of FIG. 3 when the operation for the magnetic head is stopped in step S114.

According to the processing explained referring to FIG. 3 to FIG. 7 as mentioned above, it will be examined in a short time whether the magnetic head to be examined has a necessary performance, in the head test apparatus 10 single in the first head test analysis system 1, and the function enhancing apparatus 20 is connected with the head test apparatus 10, so that detailed analytical processing such as the frequency analysis is executed for the test access signal obtained with the head test apparatus 10. When the function enhancing apparatus 20 is connected with the head test apparatus 10, taking of the test access signal is begun in accordance with the trigger pulse generated by the use of the index pulse which is output from the head test apparatus 10, so that the function enhancing apparatus 20 appropriately takes the test access signal in synchronism with the test access. This processing makes it possible that the function enhancing apparatus 20 can appropriately and easily take and analyze the test access signal.

Next, there will be explained the second embodiment of the present invention.

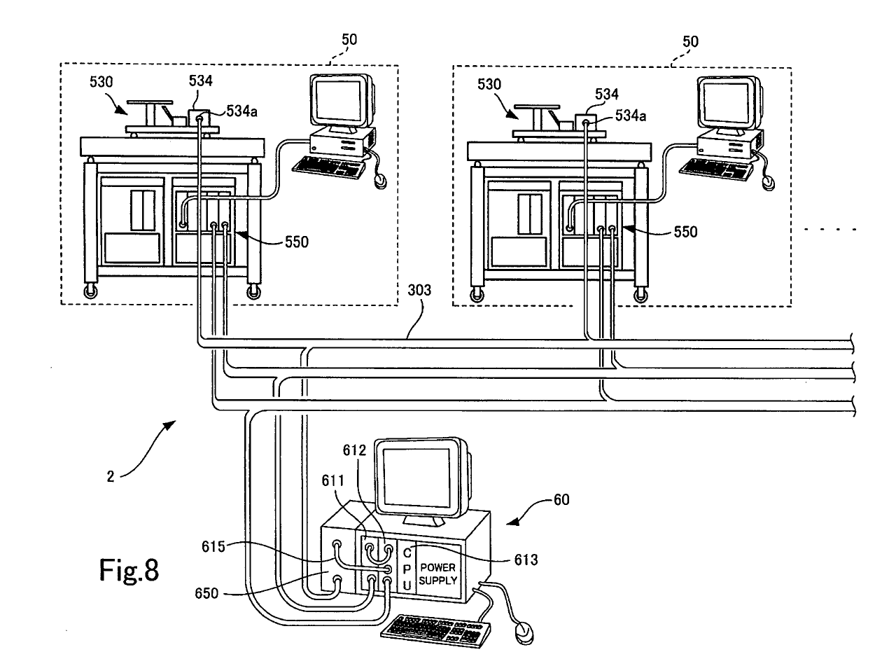

FIG. 8 is a view useful for understanding a second head test analysis system according to a second embodiment of the present invention.

A second head test analysis system 2 shown in FIG. 8 has a plurality of head test apparatuses 50 that examines whether the magnetic head to be examined has a necessary performance, and one function enhancing apparatus 60 that executes analytical processing for the access signal obtained with each the head test apparatus 50. Because each head test apparatus 50 and the function enhancing apparatus 60 respectively are devices almost equal to the head test apparatuses 10 and the function enhancing apparatus 20 in the first head test analysis system 1 of FIG. 1 that is the first embodiment of the present invention, the repetition explanation of these apparatuses is omitted in the following, and the explanation that pays attention to the difference point with the first embodiment is done.

First of all, in the head test analysis system 2 shown in FIG. 8, the function enhancing apparatus 60 executes analytical processing of the test access signal for the head test apparatus 50 with which the function enhancing apparatus 60 is connected, of two or more head test apparatuses 50. In the event that there are two or more head test apparatus 50 with which the function enhancing apparatus 60 is connected, the function enhancing apparatus 60 sequentially switches other party's apparatus and executes taking and analytical processing of the test access signal as mentioned above. According to the present embodiment, the communication board 611 and the A/DC board 612 of the function enhancing apparatus 60 have the switching function to perform such a switching.

Two or more head test apparatuses 50 of the head test analysis system 2 are mutually same apparatus, but are little different from one another in characteristics of the apparatus depending on the manufacturing error margin, system requirements, use frequency and the like. At that time, as to the head test apparatus 50 too away from a characteristic standard in characteristics of the apparatus, it involves such a problem that the credibility of the examination result is low. Thus, there is a need of measures that it is exchanged for another head test apparatus that has a standard device characteristic or some correction processing is applied to the test access signal obtained at the time of the test.

Therefore, the function enhancing apparatus 60 of the head test analysis system 2 has the evaluation function to evaluate the characteristics of the apparatus of two or more head test apparatuses 50 that compose the head test analysis system 2. The evaluation function is implemented by CPU board 613 and a standard signal input section 650 of the function enhancing apparatus 60. A combination of the CPU board 613 and the standard signal input section 650 corresponds to an example of the evaluation device referred to in the present invention. The CPU board 613 and the standard signal input section 650 correspond to the evaluation section and the standard signal input section referred to in the present invention, respectively.

The standard signal input section 650 outputs a standard signal that replaces the test access signal that the magnetic head outputs in the head test apparatus 50. According to the present embodiment, an interface section 534 of an installing section 530 of individual head test apparatus 50 is provided with an input connector 534a for inputting a standard signal from the standard signal input section 650. The standard signal is input from the standard signal input section 650 to the interface section 534 of the head test apparatus 50 through the fourth connection cable 303 connected with the input connector 534a.

The interface section 534 of the head test apparatus 50 assumes the input standard signal to be a test access signal and applies to the standard signal the signal processing such as amplification with a prescribed gain. Thus, the standard signal, which is subjected to processing, is output from a test control shelf 550 of the head test apparatus 50 to the function enhancing apparatus 60 so as to be taken by A/DC board 612 of the function enhancing apparatus 60.

According to the present embodiment, in the state that two or more head test apparatuses 50 to be evaluated are connected with the function enhancing apparatus 60, there are executed an input of the standard signal to individual head test apparatus 50 and a taking of the processed standard signal from individual head test apparatus 50.

The standard signal input section 650 inputs the standard signal while sequentially switching the head test apparatuses 50 of the input destination. The A/DC board 612 takes the processed standard signal from the head test apparatus 50 to which the standard signal is input. These a series of processing is controlled with CPU board 613 of function enhancing apparatus 60.

According to the present embodiment, the standard signal input section 650 and the A/DC board 612 are connected with one another via a standard signal cable 615, and thus the standard signal is input to the A/DC board 612. The CPU board 613 computes the processed standard signal, which will be output from the head test apparatus of a standard device characteristic, in accordance with a standard signal that passes the A/DC board 612.

The CPU board 613 of the function enhancing apparatus 60 evaluates the device characteristic of individual head test apparatus 50 by the comparison of the processed standard signal obtained from individual head test apparatus 50 with the processed standard signal obtained through the above-mentioned computation.

According to the second head test analysis system shown in FIG. 8 as explained above, for example, an operation of regularly evaluating the device characteristic of the head test apparatus 50 that composes the system makes it possible to always grasp the credibility of the examination result in individual head test apparatus 50.

In the above, as one embodiment of the head test analysis system of the present invention, there is disclosed the head test analysis system in which the magnetic head is made an object of examination and analysis. However, the present invention is not restricted to such embodiment. It is acceptable that the head test analysis system of the present invention is a head test analysis system that make heads other than the magnetic head such as optical heads accessed the optical disk where information is recorded in optics the object of the examination and the analysis for instance.

In the above, there is disclosed an embodiment in which there is executed via the connection cable the communication of various types of information such as the notifications of the access condition between the communication board of the head test apparatus and the communication board of the function enhancing apparatus. However, the present invention is not restricted to such embodiment. It is acceptable that the communication of various types of information between two communication boards is executed via the wireless for instance, and, for instance, may be executed by the Internet etc.

In the above, as one embodiment of the evaluation device referred to in the present invention, there is disclosed the evaluation device that performs only the evaluation for the device characteristic of the head test apparatus. However, the present invention is not restricted to such embodiment. It is acceptable that the evaluation device referred to in the present invention has the correction function to correct the device characteristic of the head test apparatus to a standard device characteristic in accordance with the evaluation result, for instance.

1. (canceled)

2. (canceled)

3. A head test apparatus that examines a head which accesses a recording medium and outputs an access signal obtained through the access, the head test apparatus comprising:
a loading section that installs the head;
a head operation section that causes the head installed in the loading section to execute a test access;
a test section that examines the head in such a manner that a test access signal, which is output from the head when the test access is executed, is obtained, and it is judged whether the obtained test access signal satisfies a predetermined reference;
a signal output section that obtains the test access signal and outputs the obtained test access signal to an exterior of the head test apparatus; and
a reference output section that outputs a reference signal which is used for capturing, in the exterior of the head test apparatus, the test access signal output from the signal output section in synchronism with the test access.

4. The head test apparatus according to claim 3, wherein the head operation section causes the head installed in the loading section to execute the test access under each of a plurality of types of access conditions,
the test section has references respectively associated with the plurality of types of access conditions, as the predetermined reference, and judges whether the test access signal output from the head under each access condition satisfies a reference associated with the access condition, and
the head operation section has a condition notification section that notifies an exterior of the head test apparatus of the access condition associated with the test access to be executed by the head.

5. The head test apparatus according to claim 3, wherein the test access signal is captured after a predetermined preparation is executed in the exterior of the head test apparatus,
the head test apparatus further comprises a confirmation section that performs a confirmation of completion of the predetermined preparation in the exterior of the head test apparatus, and a confirmation of termination of capturing a result of the test access in the exterior, and
the head operation section causes the head installed in the loading section to execute the test access during a period of time until the confirmation section confirms the termination of capturing after confirming the completion of the preparation.

6. The head test apparatus according to claim 3, wherein the test access signal is captured in a predetermined external device in the exterior of the head test apparatus,
the head test apparatus further comprises a detection section that detects a connection state that the predetermined external device is electrically connected with the head test apparatus,
the signal output section outputs the test access signal when the detection section detects the connection state, and
the reference output section outputs the reference signal when the detection section detects the connection state.

7. A head test analysis system comprising a head test apparatus that examines a head which accesses a recording medium and outputs an access signal obtained through the access, and an external device that captures the access signal output from the head and applies a predetermined analytical processing to the access signal,
wherein the head test apparatus comprises:
a loading section that installs the head;
a head operation section that causes the head installed in the loading section to execute a test access;
a test section that examines the head in such a manner that a test access signal, which is output from the head when the test access is executed, is obtained, and it is judged whether the obtained test access signal satisfies a predetermined reference;
a signal output section that obtains the test access signal and outputs the obtained test access signal to an exterior of the head test apparatus; and
a reference output section that outputs a reference signal which is used for capturing, in the exterior of the head test apparatus, the test access signal output from the signal output section in synchronism with the test access, and
wherein the external device captures the test access signal output from the signal output section in synchronism with the test access, in accordance with the reference signal output from the reference output section.

8. The head test analysis system according to claim 7, wherein the head test apparatus further comprises an evaluation device that has a standard signal input section for inputting a predetermined standard signal to replace the test access signal output from the head, and that has an evaluation section for obtaining an output standard signal output from the signal output section when the signal output section obtains the predetermined standard signal input by the standard signal input section and for evaluating the head test apparatus in accordance with the output standard signal.
